(19) United States
(12) Patent Application Publication
(10) Pub. No.: US 2012/0100414 A1
(43) Pub. Date: Apr. 26, 2012

(54) ENCAPSULATED EMI/RFI SHIELDING FOR A NON-CONDUCTIVE THERMOSETTING PLASTIC COMPOSITE PHEV BATTERY COVER

(75) Inventor: Kestutis A. Sonta, Troy, MI (US)

(73) Assignee: GM GLOBAL TECHNOLOGY OPERATIONS, INC., Detroit, MI (US)

(21) Appl. No.: 12/910,174

(22) Filed: Oct. 22, 2010

(51) Int. Cl. H01M 2/02

(52) U.S. Cl. 429/163

(57) ABSTRACT

A cover for a high voltage vehicle battery is disclosed that is made of a light weight, non-conductive thermoset plastic composite, such as a polyester resin matrix, and includes an EMI/RFI shield. In one embodiment, the EMI/RFI shield is a Faraday cage including a ferrous mesh that is molded into the thermoset plastic composite so that it is completely encapsulated therein. In another embodiment, the EMI/RFI shield is an acrylic polymer coating including nickel plated copper flakes formed on an outside surface of the thermoset plastic composite.

### BACKGROUND OF THE INVENTION

1. Field of the Invention

This invention relates generally to a cover for a high voltage battery for an electric vehicle and, more particularly, to a cover for a high voltage battery for an electric vehicle, where the cover is made of a non-conductive polyester resin matrix and includes electromagnetic interference (EMI) and radio frequency interference (RFI) shielding, such as a Faraday cage or an acrylic coating including nickel platted copper flakes.

2. Discussion of the Related Art

Electric vehicles are becoming more and more prevalent. These vehicles include hybrid vehicles, such as the extended range electric vehicles (EREV) that combine a battery and a main power source, such as an internal combustion engine, fuel cell system, etc., and electric only vehicles, such as the battery electric vehicles (BEV). All of these types of electric vehicles employ a high voltage battery that includes a number of battery cells. These batteries can be different battery types, such as lithium-ion, nickel metal hydride, lead acid, etc. A typical high voltage battery for an electric vehicle may include 196 battery cells providing about 400 volts of power. The battery can include individual battery modules where each battery module may include a certain number of battery cells, such as twelve cells. The individual battery cells may be electrically coupled in series, or a series of cells may be electrically coupled in parallel, where a number of cells in the module are connected in series and each module is electrically coupled to the other modules in parallel. Different vehicle designs include different battery designs that employ various trade-offs and advantages for a particular application.

The high voltage battery on an electric vehicle typically is mounted to a steel support plate and covered with a suitable protective cover that provides a number of functions. For example, the cover is a protective cover in that it prevents the battery cells from being damaged as a result of collision with other objects. Further, the cover provides electrical insulation from the high voltage of the battery to protect individuals and users. Also, the cover provides an EMI/RFI shield that absorbs radiation over a broad range of wavelengths from the high voltage battery caused by turning on and off various current flows, which otherwise could interfere with the vehicle radio, cell phone operation, etc. The steel cover provides the EMI/RFI shielding because it includes ferrous alloys.

Known covers for vehicles are typically steel covers that provide the necessary structural integrity to protect the battery cells, and when bolted to the vehicle chassis, provide electrical insulation. Further, the steel cover includes ferrous alloys and materials that provide the EMI/RFI shielding. However, such steel covers are typically heavy, and thus add considerable weight to the vehicle.

### SUMMARY OF THE INVENTION

In accordance with the teachings of the present invention, a cover for a high voltage vehicle battery is disclosed that is made of a light weight, non-conductive thermoset plastic composite, such as a polyester resin matrix, and includes an EMI/RFI shield. In one embodiment, the EMI/RFI shield is a Faraday cage including a ferrous mesh that is molded into the thermoset plastic composite so that it is completely encapsulated therein. In another embodiment, the EMI/RFI shield is an acrylic polymer coating including nickel plated copper flakes formed on an outside surface of the thermoset plastic composite.

Additional features of the present invention will become apparent from the following description and appended claims, taken in conjunction with the accompanying drawings.

### BRIEF DESCRIPTION OF THE DRAWINGS

FIG. 1 is a top plan view of a vehicle including a vehicle battery;

FIG. 2 is a cut-away perspective view of a cover for a high voltage vehicle battery being made of a thermoset plastic composite that encapsulates a Faraday cage; and

FIG. 3 is a perspective view of a cover for a high voltage vehicle battery being made of a thermoset plastic composite including an outer coating of an acrylic polymer including nickel plated copper flakes.

### DETAILED DESCRIPTION OF THE EMBODIMENTS

The following discussion of the embodiments of the invention directed to a protective battery cover for a high voltage battery in an electric vehicle is merely exemplary in nature, and is no way intended to limit the invention or its applications or uses. For example, the battery cover is specifically described for a vehicle battery. However, as well be appreciated by those skilled in the art, the battery cover may have application for other high voltage non-vehicle batteries.

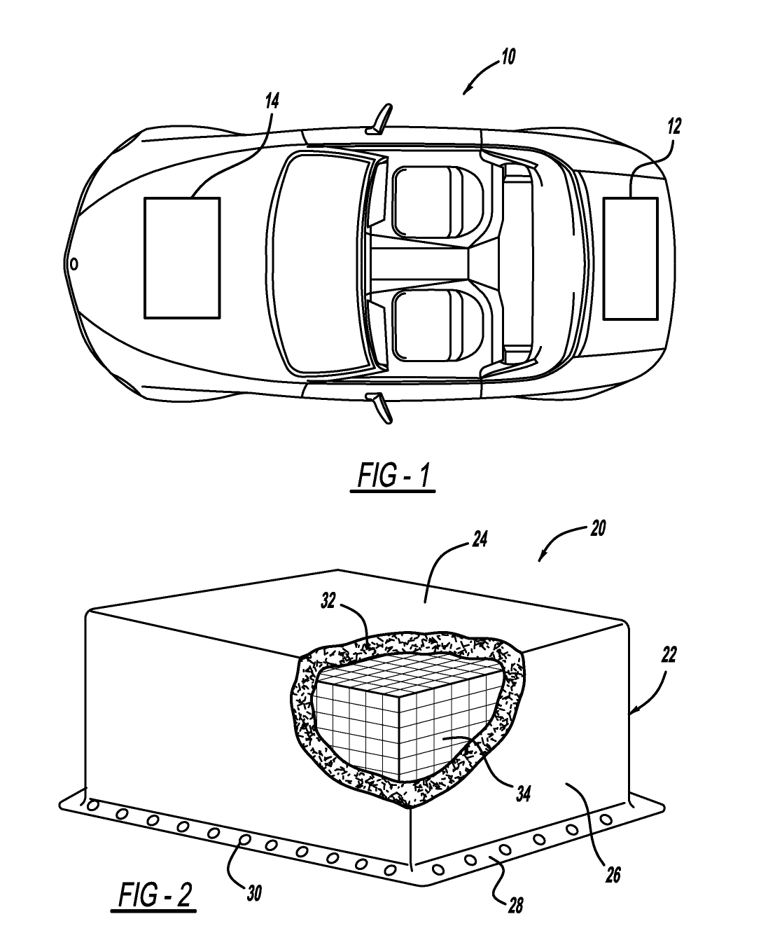

FIG. 1 is a top plan view of a vehicle 10 intended to represent an electric vehicle or an electric hybrid vehicle. The vehicle 10 includes a high voltage battery 12 mounted to a suitable support within the vehicle 10. The battery 12 can be any battery suitable for an electric vehicle, such as a lead-acid battery, lithium-ion battery, metal hydride battery, etc. The vehicle 10 may also include a separate power source 14, such as an internal combustion engine, fuel cell system, etc. As discussed above, the battery 12 would include a battery cover that provided protection for the battery 12, electrical insulation for the battery 12 and EMI/RFI shielding for electromagnetic energy generated by the battery 12.

FIG. 2 is a cut-away perspective view of a battery cover 20 suitable for covering the battery 12 in the vehicle 10, and providing the desired functions. The cover 20 has a general box-shaped housing 22 including a plate 24 and side walls 26. A rim of the housing 22 is formed by a flange 28 that extends around the cover 20 and includes bolt holes 30 that allow the cover 20 to be bolted to a support piece (not shown) on which the battery 12 is mounted.

In this embodiment, the cover 20 is a single piece unit molded and formed from a non-conductive thermoset plastic composite 32, such as a polyester resin matrix. The polyester resin matrix typically has long glass fibers in the range of 100-150 mm that provide structural integrity. The thermoset plastic composite 32 is a molded material and as such can accept other components when it is formed. According to this embodiment, a Faraday cage 34 is formed within the composite 32, where the cage 34 is a ferrous mesh including lines of a suitable ferrous metal, such as steel and nickel alloys, that provide EMI/RFI shielding. Thus, the cover 40 provides the desired structural integrity, the desired electrical insulation and the desired EMI\RFI shielding, but has a relatively low weight as a result of the composite. Further, by using a molding process to form the shape of the housing 22, significant design flexibility can be employed to provide the cover geometry in different and possibly complex shapes.

The thermoset plastic composite 32 is a material formed by special pre-form processes known by those skilled in the art. The composite 32 is formed by providing fiber glass strands with a binder. The fiber glass strands are sprayed onto a pre-form mandrel and dried in the shape of the cover 20. The preformed fiber structure is placed into the mold. The cage 34 is then placed inside of the pre-formed fiber structure and the resin is poured into the fiber structure including the Faraday cage 34. When the compression mold is closed and the resin is forced up the sides of the mold and into and around the fiber structure and the cage 34. The resin then cures over time and the compression mold is opened so that the part can be removed, where the cage 34 is completely encapsulated within the resin. By encapsulating the cage 34 in the resin, the cover 20 retains a non-conductive surface.

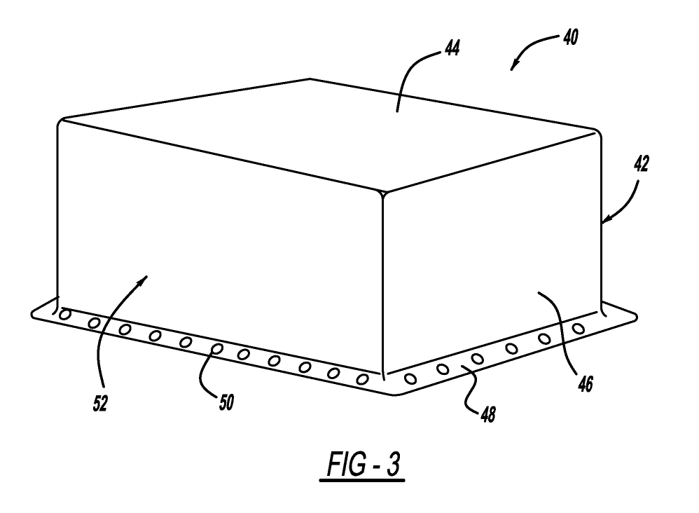

FIG. 3 shows another embodiment of a cover 40 suitable to cover the battery 12 discussed above. As with the cover 20, the cover 40 includes a housing 42 having a plate 44, side walls 46 and a mounting flange 48 with bolt holes 50. Further, the cover 40 is a single piece molded member formed by a pre-forming process using a non-conductive, thermoset plastic composite, such as a polyester resin matrix including fiber glass having long glass fibers in the range of 100-150 mm in length.

In this embodiment, an outside surface of the housing 42 is coated with an acrylic polymer coating 52 including nickel plated copper flakes. The coating 52 is painted on the outside surface of the cover 40 using any suitable process, such as brushing, to any suitable thickness so that the nickel plated copper flakes disbursed within the coating 52 provide the desired EMI\RFI shielding. The interior surface of the cover 40 is not coated with the polymer coating so that it retains its non-conductive insulation properties.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A protective cover for a battery comprising:
a single piece housing including a top plate and side plates forming an enclosure, said housing being formed from a molded non-conductive thermoset plastic composite; and
an electromagnetic interference and radio frequency interference (EMI/RFI) shield formed on or in the housing.

2. The cover according to claim 1 wherein the thermoset plastic composite includes a polyester resin matrix having glass fibers.

3. The cover according to claim 2 wherein the glass fibers have a length in the range of 100-150 mm.

4. The cover according to claim 1 wherein the EMI/RFI shield is a Faraday cage defined by a ferrous metal mesh that is encapsulated within the thermoset plastic composite.

5. The cover according to claim 1 wherein the EMI/RFI shield is an acrylic polymer coating including metal particles formed on a surface of the housing.

6. The cover according to claim 5 wherein the metal particles are nickel plated copper flakes.

7. The cover according to claim 5 wherein the acrylic polymer coating is formed only on outside surface of the housing.

8. The cover according to claim 1 wherein the housing includes a circumferential flange extending around the housing for mounting the housing to a mounting member.

9. The cover according to claim 1 wherein the battery is a high voltage battery on an electric or hybrid vehicle.

10. A protective cover for a high voltage battery on an electric or hybrid vehicle, said cover comprising:
a single piece housing including a top plate and side plates forming an enclosure, said housing being formed from a molded non-conductive thermoset plastic composite; and
a Faraday cage defined by a ferrous metal mesh encapsulated within the thermoset plastic composite.

11. The cover according to claim 10 wherein the thermoset plastic composite includes a polyester resin matrix having glass fibers.

12. The cover according to claim 11 wherein the glass fibers have a length in the range of 100-150 mm.

13. The cover according to claim 10 wherein the housing includes a circumferential flange extending around the housing for mounting the housing to a mounting member.

14. A protective cover for a high voltage battery on an electric or hybrid vehicle, said cover comprising:
a single piece housing including a top plate and side plates forming an enclosure, said housing being formed from a molded non-conductive thermoset plastic composite; and
an acrylic polymer coating including metal particles formed on a surface of the housing.

15. The cover according to claim 14 wherein the thermoset plastic composite includes a polyester resin matrix having glass fibers.

16. The cover according to claim 15 wherein the glass fibers have a length in the range of 100-150 mm.

17. The cover according to claim 14 wherein the metal particles are nickel plated copper flakes.

18. The cover according to claim 14 wherein the acrylic polymer coating is formed only on outside surface of the housing.

19. The cover according to claim 14 wherein the housing includes a circumferential flange extending around the housing for mounting the housing to a mounting member.
